(19) United States
(12) Patent Application Publication
(10) Pub. No.: US 2017/0050339 A1
(43) Pub. Date: Feb. 23, 2017

(54) PROCESS & ASSEMBLY FOR RECYCLING SCRAP MATERIAL IN ANY OF A NUMBER OF REUSABLE FORMS INCLUDING POWDER, PELLETS, SHEETS, PREFORMS & EXTRUSIONS

(71) Applicant: Oria Collapsibles, LLC, Auburn Hills, MI (US)

(72) Inventor: Miguel A. Linares, Bloomfiel Hills, MI (US)

(21) Appl. No.: 15/235,188

(22) Filed: Aug. 12, 2016

Related U.S. Application Data
(60) Provisional application No. 62/207,165, filed on Aug. 19, 2015.

(51) Int. Cl. B29B 11/08; B29C 45/00; B29B 17/04

(52) U.S. Cl. CPC B29B 11/08; B29B 17/04; B29C 45/0001; B29K 2101/10

(57) ABSTRACT

The present invention discloses a process for recycling and repurposing a scrap material into a stock reusable material, including the steps of providing a scrap material, mechanically reducing the scrap material into a desired particulate size, mixing the particulate with a plasticized based syrup, and reforming the homogenous mixture into a repurposed article. The step of processing impurities from the scrap material is further conducted to achieve a desired purity and the mixture can be formed into any of a powder, pellet, sheet preform or extrusion. Additional steps include any of injection molding, compression molding, thermoforming, slush, transfer or rotational molding operations. Separately, the mixture can be reformed using an extrusion operation.

### CROSS-REFERENCE TO RELATED APPLICATIONS

This Application claims the benefit of U.S. Provisional Application 62/207,165 filed on Aug. 19, 2015, the contents of which is incorporated herein in its entirety.

### FIELD OF THE INVENTION

The present inventions disclose a process and assembly for and repurposing scrap material into a stock reusable material including any one or more of a powder, pellet, sheet, preform or extrusion. The inventions further contemplate the use of any plastic or plasticized composite, intermixed with the scrap material once reduced to a finely ground consistency, and in order to create the stock reusable material according to any of the above described.

### BACKGROUND OF THE INVENTION

The prior art is documented with examples of reprocessing/recycling assemblies and processes for reusing scrap material, such being typically reground or pulverized and subsequently recast or reformed (such as via a press molding or extrusion process) into a reconstituted or reusable article. A first example of this is depicted in U.S. Pat. No. 8,361,358, to Wolf, which teaches a method of recycling fiberglass reinforced plastics including the steps of grinding scraps of such material and then mixing the same with a mixing agent to form a composite material that is heated in order to cure the material to firm a panel.

GB 2520634 teaches a particulate waste (scrap) material which is processed into a constructional material, such as an aggregate used in road construction. EP 2 562 206, teaches a process for forming a shaped part including the steps of sectioning a fiber strengthened plastic into a matrix including a thermosetting polymer, adding a bonding agent including any of a thermosetting polymer forerunner, thermoplastic elastomer, elastomer forerunner, thermosetting polymer, and arbitrary mixture thereof, and forming the mixture to a shaped part from the carbon fiber-strengthened plastic.

Sethu, US 2014/0220280, teaches a process of recycling plastic waste including each of segregating plastic waste collected from various sources followed by cleaning of the segregated plastic waste to obtain segregated cleaned waste, grinding of the segregated cleaned waste to obtain grinded waste, introducing the grinded waste into an extrusion line having a venting extruder component as part of the extrusion line, to obtain molten plastic, and removing the impurities by vacuum venting of the molten plastic to obtained recycled plastic free from impurities. The disclosure further relates to various articles like Industrial Post Recycled (IPR) plastic tubes, blow moulded bottles, pallates, manufactured from the recycled plastic waste.

Kao, U.S. Pat. No. 9,034,227 teaches a method of making a flexible foaming member from recycled material containing rubber, plastic and metal materials, which are pulverized into scraps under normal temperatures. Additional steps roughly separate the various materials contained in the waste scraps into different layers based on the difference of specific gravity and can remove the scraps of rubber and plastic materials with lower specific gravity from the waste scraps.

Kao further teaches multiple heating and pulverization steps follow under different temperatures to produce composite-material scraps, following which composite-material scraps are utilized to mix flexible materials and foaming agents, the resulting mixture being pressed into a plate-like foaming material, following which a vulcanization and foam forming process to the plates of foam material converts the same into an elastic foam.

WO 2008/020768, Orica, teaches a composite material manufactured from waste materials and including a binder system including a waste powder coating, such as in the form of water resistant board (thermosetting resin such a polyester, epoxy, or thermoplastic powder) together with a water based acrylic paint. A board is made by mixing together from 15% to 30% of waste powder (polyester thermosetting resin), with sawdust having a particle size typically below 3 mm (40% to 75″ sawdust composition in the mix). All of the ingredients are mixed in a low shear mixer, then molded under heat and pressure (either continuously or in individual molds) to allow the thermoplastic and thermosetting resins to cure, and to encapsulate the sawdust particles to produce a waterproof composite board.

Finally, WO 2016/082595, to Shiung Fire Cremator Co., Ltd., discloses a method for manufacturing an environmentally friendly electronic board using recycled materials, such a plastic bottles, or products or materials made from recycled polyethylene (PE), waste polypropylene (PP), polyethylene terephthalate (PET) or other mixture materials. Steps include forming recycled waste husks which are heated, melted, kneaded and mixed in proportion to weight, following which the semi-finished products are coarsely or finely crushed to form plastic particles. The particles are then melted by using an injection molding machine, a squeeze molding machine or an extrusion molding machine, and are injected into a mold and are subjected to pressing or extrusion so as to form an electronic board.

### SUMMARY OF THE INVENTION

The present invention discloses a process for recycling and repurposing a scrap material into a stock reusable material, including the steps of providing a scrap material, mechanically reducing the scrap material into a desired particulate size, mixing the particulate with a plasticized based syrup, and reforming the homogenous mixture into a repurposed article. The step of processing impurities from the scrap material is further conducted to achieve a desired purity and the mixture can be formed into any of a powder, pellet, sheet preform or extrusion.

To further assist in reforming, a chemical catalyst or binding agent/composition can be integrated into either the plasticized syrup or mixed into the combined composition including the syrup and granulate. Additional steps include any of injection molding, compression molding, thermoforming, slush, transfer or rotational molding operations. Separately, the mixture can be reformed using an extrusion operation.

The step of mixing further contemplates providing at least one of a propylene, an ester, a phthalate, or a trimellitate into the plasticized syrup. A granulated material can be admixed with the plasticized syrup. Either of a thermoplastic or thermosetting component can be incorporated into the plasticized syrup.

### BRIEF DESCRIPTION OF THE DRAWINGS

Reference will now be made to the attached drawings, when read in combination with the following detailed description, where like reference numerals refer to like parts throughout the several views, and in which:

FIG. 1 is flow schematic of the process and assembly for recycling and repurposing scrap material into a stock reusable material including any one or more of a powder, pellet, sheet, preform or extrusion according to one non-limiting variant of the present invention; and

FIGS. 2A-2D is a non-limiting example of a close mold process for creating a finished preform and reusable stock material according to one non-limiting example of the present inventions.

### DETAILED DESCRIPTION OF THE PREFERRED EMBODIMENTS

As previously described, the present inventions disclose a variety of processes and assemblies for recycling and repurposing a scrap material into a stock reusable material including any one or more of a powder, pellet, sheet, preform or extrusion. The present inventions further contemplate the use of any plastic or plasticized composite, intermixed with the scrap material once reduced to a finely ground consistency, and in order to create the stock reusable material according to any of the above described.

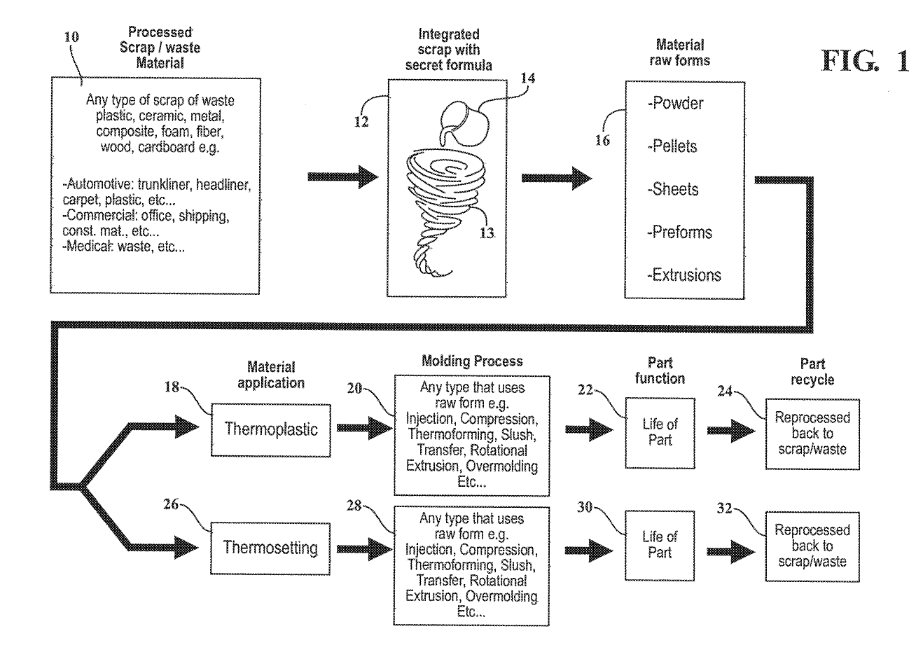

Initially referring to FIG. 1, a flow schematic is depicted of the process and assembly for recycling and repurposing scrap material into a stock reusable material, this including (at step 10) providing a processed scrap or waste material including any of a plastic, ceramic, metal, composite, foam, fiber, wood or cardboard. Without limitation, the scrap materials 10 can be procured from such as automotive trunkliners, headliners, carpets, plastics etc. Additional non limiting examples of scrap materials also include commercial materials such as derived from office, shipping, construction, materials, etc. Other known scrap materials can include medical waste and the like.

Although not shown, the waste material is reduced to a fine granular form through the use of an industrial grinder, such including any plurality of teethed mashing gears or rollers. Depending upon the size and condition of the waste material, additional reducing or filtering steps can be provided, such as including but not limited to chopping or other mechanical sectioning operations (such intended to reduce an initially sized waste material to an intermediate or subset size for subsequently feeding into the industrial grinder).

At step 12, the now filtered/granulated waste material is placed into an industrial sized blender (at 13) along with a plasticized syrup 14, such further consisting of a mixture of any known or proprietary composition of polymers or composites thereof. The polymer, such potentially including a mixture or ratio of ingredients not limited to a propylene, ester, phthalate, trimellitate and/or other component(s), is intended to uniformly admix with the granulated material and function as a binder once the homogenous mixture is reduced to the desired reusable/re-purposed stock form.

As is further understood, any type of chemical catalyst or chemical bonding agent/composition can be integrated into the plasticized syrup (such as either before and/or after mixing with the previously ground particulate materials). Catalysis is the increase in the rate of a chemical reaction due to the participation of an additional substance called a catalyst. With a catalyst, reactions occur faster and require less activation energy. Because catalysts are not consumed in the catalyzed reaction, they can continue to catalyze the reaction of further quantities of reactant. Often only tiny amounts are required. As is further known, polymers have been widely used as catalysts or catalyst supports and the various applications can be categorized conveniently into four groups, including (a) catalysis by soluble linear polymers, (b) catalysis by ion exchange resins, (c) polymer-supported ‘homogeneous’ metal complex catalysts and (d) polymer-supported phase transfer catalysts.

The rate of reaction refers to the amount of reactant consumed or product formed per unit of time at a given temperature and pressure. Generally speaking, the rate of reaction goes up as the temperature of the reaction is raised. This is related to the fact that most reactants have to “climb” over one or more energy barriers to reach the product stage. Raising the reaction temperature ultimately imparts more energy to the reactants, creating a greater probability that more of them will be energetic enough to traverse the barrier, and this results in a faster rate.

As previously stated, a catalyst does not change the energetic characteristics of the reactants and products and the barriers between them. It instead finds an alternate reaction pathway that bridges reactants and products, and one that has lower (and thus easier-to-traverse) energy barriers. An alternate pathway means a faster reaction rate. Although a catalyst can itself be considered a reactant, it is regenerated, unchanged, at a later stage in the catalytic process. The regenerated catalyst can then be used to catalyze another like reaction. Thus, in principle, only a very small amount of catalyst is needed to generate copious amounts of product.

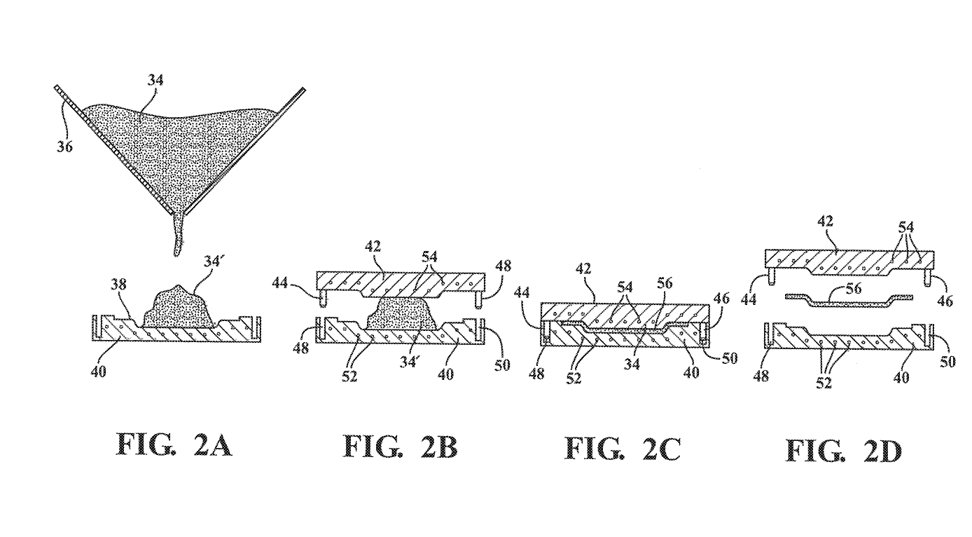

Bonding agents are natural, compounded or synthetic materials used to enhance the joining of individual members of a structure without employing mechanical fasteners. These products are often used in repair applications such as the bonding of fresh concrete, sprayed concrete or sand/cement repair mortar to hardened concrete. In the proposed application, the catalyst or bonding agent/composition is provided as an ingredient to the plasticized syrup and, when intermixed therewith (typically immediately before and/or after admixing with the previously ground material) facilitates setting of the mixture (such as within the specific mold or extrusion application). As will be further referenced in FIGS. 2A-2D, the molds can be heated to facilitate the curing/setting process, either alternatively or in combination with the selection of a catalyst or bonding agent.

The plasticized syrup can also incorporate additional components such as particulates or the like for providing desired material properties depending upon the environmental conditions uncovered. For purposes of the present description, components of the plasticized syrup may further include any component, percentage or ratio of a polystyrene, polyurethane or other material which can maintain structural integrity once molded, extruded, or otherwise casted with the homogeneously mixed stock material, and while also delivering long term environmental protection. Such may further incorporate water-based surface modifiers, additives and polymers for numerous industries and applications including wood care, industrial coatings, inks, fibers, composites, and construction products.

At succeeding step 16, the ground and blended/homogenously mixed material is subsequently formed, from its soupy composition, into any of a powder, pellet, sheet, preform, extrusion or the like. This forming step contemplates the use of any known forming or casting assembly or structure (such as the closed mold process of FIG. 2) for converting the homogenous admixture of step 12 into any of powder, pellet, sheet, preform or extruded raw form.

A first material application of the admixed raw form is in the production of a thermoplastic (step 18), such as which can be utilized in a mold process (step 20) not limited to any of injection, compression, thermoforming, slush, transfer, rotational, extrusion or over-molding mold processes. The part thereby produced (step 22) functions for a given life cycle and, further at step 24, is reprocessed back into scrap/waste (see also previous step 10) for disposal or subsequent recycling.

Steps 26-32 correspond to steps 18-24 described above and as applied to a therrnosetting material. As known, a thermoset material is a prepolymer material that cures irreversibly. The cure may be induced by heat, generally above 200° C. (392° F.), through a chemical reaction, or suitable irradiation. Thermoset materials are usually liquid or malleable prior to curing and designed to be molded into their final form. Once hardened, a thermoset resin cannot be reheated arid melted to be shaped differently.

Thermosetting resin may be contrasted with thermoplastic polymers, which are commonly produced in pellets and shaped into their final product form by melting and pressing or injection molding. A thermoplastic, or thermosoftening plastic, is a plastic material that becomes pliable or moldable above a specific temperature and solidifies upon cooling.

Most thermoplastics have a high molecular weight. Thermoplastics may be reshaped by heating and are typically used. to produce parts by various polymer processing techniques such as injection molding, compression molding, calendering, and extrusion. In this respect, thermoplastics differ from thermosetting polymers as discussed above, which form irreversible chemical bonds during the curing process and, as such, do not melt but decompose and do not reform upon cooling.

Referring now to FIG. 2, a on-limiting example of a close mold process is shown for creating a finished preform and reusable stock material according to one non-limiting example of the present inventions. The forming process includes a first stage (FIG. 2A) in which a combined mixture 34 (see also at step 16 in FIG. 1) is shown in a powder form and is fed through a funnel 36 into an open interior cavity 38 of a first lower mold half 40.

As further shown, an upper mold half 42 is provided (FIGS. 2B-2D) and includes downwardly projecting locating pins (see at 44 and 46) which, upon aligning with seating apertures (further at 48 and 50) associated with the lower mold half 40, clamp the mold halves together in a manner to compress the previously deposited volume of fluidic recipe mixture 34′. The mold halves 40/42 each further can include any combination of heating coils or elements (see further at 52/54 for respective mold halves 40/42) for assisting in curing and setting the recipe mixture into a panel shaped (repurposed) article (reference again being made to the optional and/or concurrent use of a chemical catalyst, additive or bonding agent), at FIG. 2C, prior to removal the finished article, generally represented in side profile at 56 and which is ejected as a completed article from the reopened mold (FIG. 2D).

Without limitation, and as previously described at concurrent steps 20/28, any type of mold, extrusion or other forming process can be employed in the final reshaping of the raw form mixture (step 16) into a repurposed article. The present inventions further contemplate any associated process or mechanism for assisting in any one or more of the steps of grinding (including crushing and abrading) the pre-processed scrap material into a desired reduced particulate size, homogenously mixing the particulate with the known or proprietary plasticized syrup, and molding or otherwise reforming the completed article into a repurposed part.

Having described my invention, other and additional preferred embodiments will become apparent to those skilled in the art to which it pertains, and without deviating from the scope of the appended claims.

I claim:

1. A process for recycling and repurposing a scrap material into a stock reusable material, comprising the steps of:
providing a scrap material;
mechanically reducing the scrap material into a desired particulate size;
mixing the particulate with a plasticized based syrup; and
reforming the homogenous mixture into a repurposed article.

2. The process as described in claim 1, further comprising the step of processing impurities from the scrap material to achieve a desired purity.

3. The process as described in claim 1, further comprising the step of forming the mixture into any of a powder, pellet, sheet preform or extrusion.

4. The process as described in claim 3, the step of reforming the mixture further comprising any of injection, compression, thermoforming, slush, transfer or rotational molding operations.

5. The process as described in claim 3, the step of reforming the mixture further comprising an extrusion operation.

6. The process as described in claim 1, the step of mixing fluffier comprising providing at least one of a propylene, an ester, a phthalate, or a trimellitate into the plasticized syrup.

7. The process as described in claim 6, the step of mixing further comprising further admixing a granulated material with the plasticized syrup.

8. The process as described in claim 6, the step of mixing further comprising incorporating either of a thermoplastic or thermosetting component into the plasticized syrup.

9. A process for recycling and repurposing a scrap material into a stock reusable material, comprising the steps of:
providing a scrap material;
processing impurities from the scrap material to achieve a desired purity;
mechanically reducing the scrap material into a desired particulate size;
mixing the particulate with a plasticized based syrup, the step of mixing further including providing at least one of a propylene, an ester, a phthalate, or a trimellitate into the plasticized syrup; and
reforming the homogenous mixture into a repurposed article.

10. The process as described in claim 9, further comprising the step of forming the mixture into any of a powder, pellet, sheet preform or extrusion.

11. The process as described in claim 10, the step of reforming the mixture further comprising any of injection, compression, thermoforming, slush, transfer or rotational molding operations.

12. The process as described in claim 10, the step of reforming the mixture further comprising an extrusion operation.

13. The process as described in claim 9, the step of mixing further comprising further admixing a granulated material with the plasticized syrup.

14. The process as described in claim 9, the step of mixing further comprising incorporating either of a thermoplastic or thermosetting component into the plasticized syrup.

15. A process for recycling and repurposing a scrap material into a stock reusable material, comprising the steps of:
providing a scrap material;
processing impurities from the scrap material to achieve a desired purity;
mechanically reducing the scrap material into a desired particulate size;
mixing the particulate with a plasticized based syrup, the step of mixing further including providing at least one of a propylene, an ester, a phthalate, or a trimellitate into the plasticized syrup;
further admixing at least one of a chemical catalyst or bonding agent/composition into said syrup before or after intermixing with said particulate; and
reforming the homogenous mixture into a repurposed article via an injection molding operation in which a measured volume of admixed material is introduced into an inner cavity associated with a lower mold half, an upper mold half being secured there over in order enclosed the cavity an to promote even dispersion of the mixture across the surfaces of the cavity, at least one of a heating element integrated into the mod or a heat of curing chemically resulting from said catalyst/binding agent facilitating hardening and setting of the mixture within the mold.

16. The process as described in claim 15, the step of mixing further comprising further admixing a granulated material with the plasticized syrup.

17. The process as described in claim 15, the step of mixing further comprising incorporating either of a thermoplastic or thermosetting component into the plasticized syrup.
